(19) United States
(12) Patent Application Publication
(10) Pub. No.: US 2026/0270315 A1
(43) Pub. Date: Sep. 10, 2026

(54) CONNECTION SETUP BETWEEN DEVICES

(71) Applicant: Hewlett-Packard Development Company, L.P., Spring, TX (US)

(72) Inventors: ChangNam AN, Seongnam Si (KR); Hyungjong KANG, Seongnam Si (KR); SungJin AHN, Seongnam Si (KR)

(21) Appl. No.: 18/871,863

(22) PCT Filed: Nov. 8, 2022
(86) PCT No.: PCT/US2022/049233

§ 371 Date: Dec. 5, 2024

(30) Foreign Application Priority Data
Jun. 9, 2022 (KR) 10-2022-0070177

(51) Int. Cl. H04L 67/141; H04L 67/306

(52) U.S. Cl. CPC H04L 67/141; H04L 67/306

(57) ABSTRACT

An example method for connection between devices, includes obtaining first information and second information, the first information including information regarding installation of a cloud application on a first device and information regarding a user account thereof, the second information including information regarding installation of a cloud application on a second device and information regarding a user accounts thereof, and indicating, based on the first information and the second information, whether each of the first device and the second device is logged in to an identical cloud application with an identical user account.

### BACKGROUND

There exist many different types of image forming devices, including dedicated printers, scanners, copiers, facsimile machines, etc., and also multi-function products (MFPs) that act as an all-in-one solution to provide a combination of, e.g., print, copy, scan, and fax functions.

Based on carrying out a scan job, a print job, or the like with an image forming device, a user may need to install a cloud application in a host device, as well as in the image forming device, to use the service of the cloud application. In this connection, the user may need to check whether each of the devices has an identical application installed therein and whether that device is logged in to the application with an identical account.

### BRIEF DESCRIPTION OF THE DRAWINGS

Various examples will be described below by referring to the following figures.

FIG. 1 is a diagram illustrating a system to perform a connection between devices according to an example.

FIG. 2 is a diagram illustrating a screen which is indicated on a portal according to an example.

FIG. 3 is a diagram illustrating information stored in a first server and information stored in a second server according to an example.

FIG. 4 is a diagram illustrating a process of indicating cloud applications installed on a first device and a second device according to an example.

FIG. 5 is a diagram illustrating information regarding installation of cloud applications according to an example.

FIG. 6 is a diagram illustrating a selection of a device based on the information regarding the installation of cloud applications according to an example.

FIG. 7 is a diagram illustrating a process in which a first server indicates whether each of the first device and the second device is logged in to an identical cloud application with an identical user account according to an example.

FIG. 8 is a diagram illustrating an indication of whether each of the first device and the second device is logged in to an identical cloud application with an identical user account according to an example.

FIG. 9 is a diagram illustrating a process of installing a first cloud application which is not yet installed both on the first device and on the second device according to an example.

FIG. 10 is a diagram illustrating a process of ensuring that each of the first device and the second device is logged in to an identical cloud application with an identical user account according to an example.

FIG. 11 is a flow diagram illustrating a method for connection between devices according to an example.

FIG. 12 is a block diagram schematically illustrating a first server according to an example.

FIG. 13 is a schematic illustration of a non-transitory computer readable recording medium having stored therein a computer program including instructions executable by a processor to perform operations according to an example.

### DETAILED DESCRIPTION

Hereinafter, various examples will be described with reference to the drawings. Like reference numerals in the specification and the drawings denote like elements, and thus a redundant description may be omitted.

As part of carrying out a scan job, a print job, or the like with an image forming device, a user may install a cloud application in a host device, as well as in the image forming device, to use the service of the cloud application. For example, the user may desire to use the same cloud application both in the host device and in the image forming device. For example, the user may desire to upload a document scanned at the image forming device to the cloud application installed thereon and view the uploaded document in the cloud application installed on the host device. In another example, the user may desire to connect to the cloud application on the image forming device to print the document that is already uploaded to the same cloud application on the host device. In this connection, the user may check whether each of the devices has an identical application installed therein and whether that device is logged in to the application with an identical account.

In such case, the user may find it less convenient to check, through each of the host device and the image forming device, what cloud applications are installed in that device, or to go through an additional login/logout procedure so that each of the devices may be logged in to an identical cloud application with an identical account.

In an example of the present disclosure, a user is able to easily experience synchronized installation of a cloud application both on a host device and an image forming device and synchronized login with an identical account of each of the devices to the installed cloud application.

Various terms used in the present disclosure are chosen from a terminology of commonly used terms in consideration of their function herein, which may be appreciated differently depending on an intention of a user, a precedent case, or an emerging new technology. In specific instances, some terms are to be construed as set forth in the detailed description. Accordingly, the terms used herein are to be defined consistently with their meanings in the context of the present disclosure, rather than simply by their plain and ordinary meaning.

While these examples are susceptible of various modifications and alternative forms, certain features thereof are illustrated by the accompanying drawings, and herein described in detail, with the understanding that the present disclosure is to be considered as illustrative and not restrictive. Various changes, equivalents, and substitutes are contemplated that fall within the spirit and technical scope of the present disclosure. The terms as used herein are to be given a broad interpretation commensurate with the teachings of the present disclosure.

It will be understood that terms, such as those defined in commonly used dictionaries, should be interpreted as having a meaning that is consistent with their meaning in the context of the relevant art and will not be interpreted in an idealized or overly formal sense unless expressly so defined herein.

It is contemplated that some of the individual features described in one of the drawings may be implemented independently from each other or in combination.

The terms “comprising,” “including,” “having,” “containing,” etc. are used herein to specify the presence of the elements listed thereafter. Unless otherwise indicated, these terms and variations thereof are not meant to exclude the presence or addition of other elements.

As used herein, the ordinal terms “first,” “second,” and so forth are meant to identify several similar elements. Unless otherwise specified, such terms are not intended to impose limitations, e.g., a particular order of these elements or of their use, but rather are used merely for referring to multiple elements separately. For instance, an element may be referred to in an example with the term “first” while the same element may be referred to in another example with a different ordinal number such as “second” or “third.” In such examples, such ordinal terms are not to limit the scope of the present disclosure. Also, the use of the term “and/or” in a list of multiple elements is inclusive of all possible combinations of the listed items, including any one or plurality of the items.

The term “image forming job” as used herein may encompass any of a variety of image-related jobs that involve an operation of forming an image and/or other processing operations, e.g., creation, generation, and/or transfer of an image file. The term “job” as used herein may encompass a chain of processes that facilitate an image forming job, as well as the image forming job per se. By way of example and not limitation, an image forming device may perform an image forming job, such as a print job, a copy job, a scan job, a facsimile or other transmission job, a storage job, a coating job, or the like.

The term “image forming device” or “image forming apparatus” as used herein may encompass any of a variety of devices, such as a printer, a copier, a scanner, a facsimile machine, a multi-function product (MFP), a display device, and the like, that are capable of performing an image forming job. In some examples, an image forming device may be a two-dimensional (2D) or three-dimensional (3D) image forming device. Such image forming device may provide various additional functions, as well as basic ones, for example, print, copy, scan, and fax functions.

The terms “electronic device”, “electronic apparatus,” or “user device” as used herein may refer to any information processing device, such as, for example, a computer, a laptop, a tablet PC, a mobile telephone terminal, or the like, that may be used by a user.

The term “unit” as used herein may refer to a hardware component, such as a processor or other circuitry, and/or a machine readable instructions component executed by the hardware component such as the processor.

Examples of the present disclosure will now be described with reference to the accompanying drawings. The present disclosure may, however, be embodied in many different forms and should not be construed as limited to the examples set forth herein. Rather, these examples are given in order to provide a better understanding of the scope of the present disclosure.

These and other features of the examples will become apparent from the following detailed description taken in conjunction with the accompanying drawings.

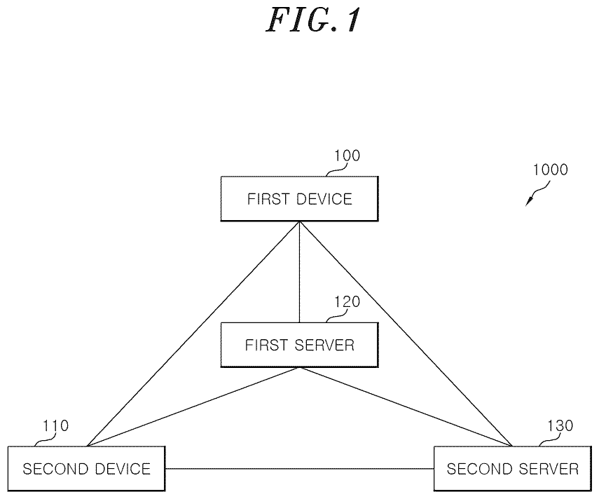

FIG. 1 is a diagram illustrating a system to perform a connection between devices according to an example.

In FIG. 1, there is shown a system 1000 that is to perform a connection between devices. In some examples, the system 1000 may include a first device 100, a second device 110, a first server 120, and a second server 130. Other examples of the system 1000 are also contemplated. For example, the system 1000 may also include an additional component.

In some examples where a plural number of devices, such as the first device 100 and the second device 110, are available to a user for using, on each of the plurality of devices, an identical cloud application to utilize a particular cloud service, the system 1000 may verify whether each of the plurality of devices is logged in to the identical cloud application with an identical user account. Further, the system 1000 may connect the plurality of devices to one another by ensuring that each of the plurality of devices is logged in to the identical application with the identical user account.

In an example, the system 1000 may connect the first device 100 and the second device 110 to each other by using the first server 120 or the second server 130 to ensure that each of the first device 100 and the second device 110 is logged in to an identical cloud application with an identical user account.

In an example, the first device 100 may be a user device. Examples of the user device may include a smart phone, a tablet PC, a smart TV, a mobile phone, a personal digital assistant (PDA), a laptop, a media player, a micro-server, a global positioning system (GPS) device, an e-book reader device, a digital broadcasting terminal, a navigation device, a kiosk device, an MP3 player, a digital camera, a consumer electronic device, a camera-equipped device, and any other mobile or non-mobile computing device.

In an example, the second device 110 may be an electronic device that is connectable for use with the first device. For example, the electronic device may be an image forming device or the like. The term “image forming device” as used herein may encompass any of a variety of devices, such as a printer, a copier, a scanner, a facsimile machine, an MFP, a display device, and the like, that are capable of performing an image forming job. In some examples, an image forming device may be a two-dimensional (2D) or three-dimensional (3D) image forming device. Such image forming device may provide various additional functions, as well as basic ones, for example, print, photocopy, scan, and fax functions.

In an example, the first server 120 may provide a service to allow the user to manage both of the first device 100 and the second device 110 through a single portal. For example, the portal may provide a web page on which the user may view information regarding the first device 100 and information regarding the second device 110 at the same time. While being used by the user, the portal may be managed based on the user's ID. The user may check whether each of the first device 100 and the second device 110 is logged in to an identical application with an identical user account and may use a particular cloud service through the portal. For example, the user may use the portal to install a cloud application that is not yet installed both on the first device 100 and on the second device 110. Further, if each of the first device 100 and the second device 110 is logged in to an identical application, but with its respective different user account, the user may initiate synchronization such that the first device 100 and the second device 110 may be logged in with a user account that is identical for both devices.

In an example, the second server 130 may provide a service for managing user accounts of the cloud application installed both on the first device 100 and on the second device 110. For example, the second server 130 may provide the user account management service based on the user's user portal ID for using the portal.

In some examples, the first device 100, the second device 110, the first server 120, and the second server 130 may communicate with one another via a network. Examples of the network may include a Local Area Network (LAN), a Wide Area Network (WAN), a Value Added Network (VAN), a mobile radio communication network, a satellite communication network, a combination thereof, and any other suitable types of data communication networks, such as a wired Internet, a wireless Internet, and a mobile wireless communication network, that facilitate communication between the network components or entities shown in FIG. 1. Such communication may be implemented using a wireless communication technology such as Wireless Fidelity (Wi-Fi), Bluetooth, Bluetooth Low Energy (BLE), Zigbee, Wi-Fi Direct (WFD), Ultra-Wide Band (UWB), Infrared Data Association (IrDA), Near-Field Communication (NFC), or the like.

In some examples, each of the first server 120 and the second server 130 may be implemented as a computing device that communicates over the network to provide instructions, code, files, content, services, and the like. The first server 120 and the second server 130 may operate independently as separate servers or together as a single combined server.

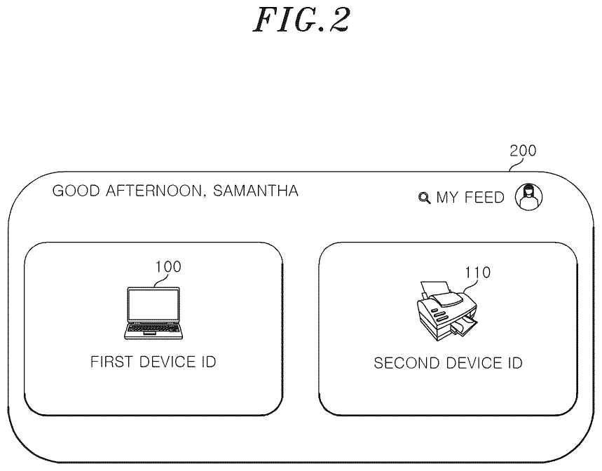

FIG. 2 is a diagram illustrating a screen which is indicated on a portal according to an example.

In some examples, the portal may be provided by the first server 120 to allow the user to manage, in one place, a plurality of devices, such as the first device 100 and the second device 110. For example, the user may make a request for registering the plurality of devices, including, e.g., the first device 100 and the second device 110, with the first server 120.

FIG. 2 shows that the user may log in to the portal with his/her user portal ID and that upon such request by the user, the first device 100 and the second device 110 may be registered with the portal. In FIG. 2, there is represented an example screen 200 of the portal with the first device 100 and the second device 110 being registered thereon.

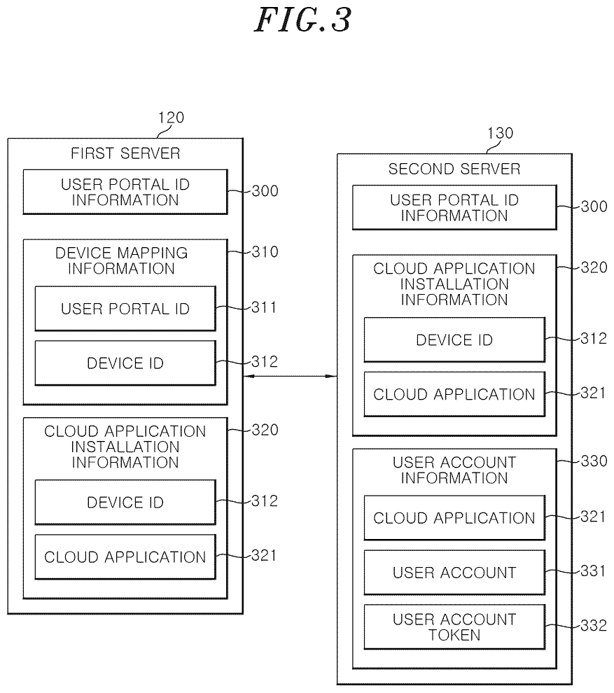

FIG. 3 is a diagram illustrating information stored in the first server and information stored in the second server according to an example.

In some examples, the first server 120 may have a database in which user portal ID information 300, device mapping information 310, and cloud application installation information 320 are stored. In other examples, different implementations are possible.

For example, the device mapping information 310 may include information regarding a mapping of the user portal ID, denoted as 311, with a device ID 312 of each of the devices registered with the portal, such as an ID of the first device 100 or an ID of the second device 110. Further, the cloud application installation information 320 may include information regarding the device ID 312 of each of the devices registered with the portal and at least one cloud application 321 installed on that device.

In some examples, the second server 130 may have a database in which the user portal ID information 300, the cloud application installation information 320, and user account information 330 are stored. In other examples, different implementations are possible. The cloud application installation information 320 may be transmitted from the first server 120. The user account information 330 may include information regarding the at least one cloud application 321, a user account 331 of the cloud application, and a user account token 332 thereof. In other examples, any suitable type of data related to authentication of the user account may be used rather than the user account token 332 of FIG. 3.

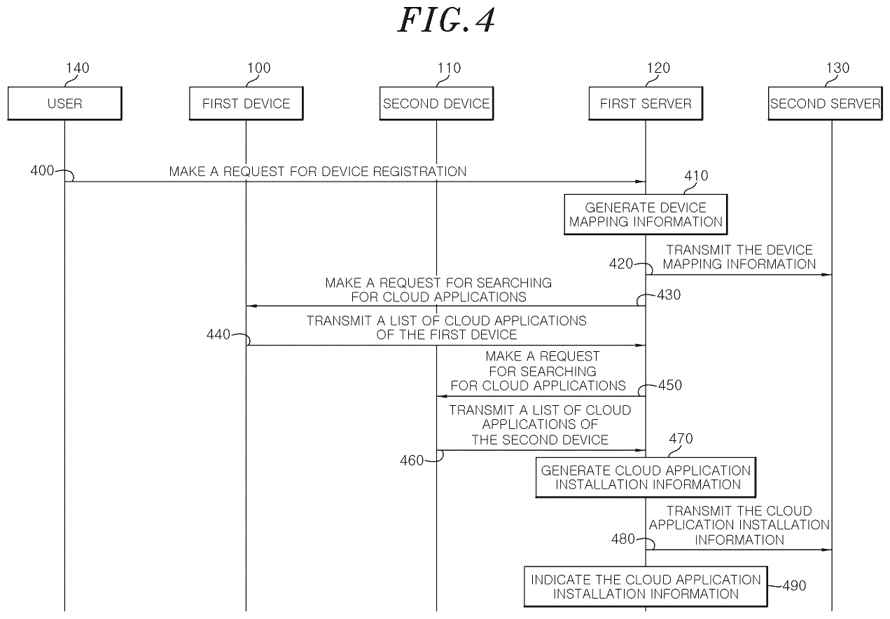

FIG. 4 is a diagram illustrating a process of indicating cloud applications installed on the first device and the second device according to an example.

In some examples, the first server 120 may obtain first information and second information. In these examples, the first information may include information regarding installation of cloud applications on the first device 100. Further, the second information may include information regarding installation of cloud applications on the second device 110. The first server 120 may indicate, based on the first information and the second information, at least one cloud application installed on each of the first device 100 and the second device 110.

FIG. 4 shows that the user of the portal, denoted as 140, may make, at operation 400, a request to the first server 120 for registration therewith of the first device 100 and the second device 110.

At operation 410, the first server 120 may generate the device mapping information. The device mapping information may include the information regarding the mapping of the user portal ID with the device ID 312 of each of the first and the second devices registered with the portal.

At operation 420, the first server 120 may transmit the device mapping information to the second server 130.

At operation 430, the first server 120 may make a request to the first device 100 for searching for the cloud application(s) installed on the first device 100.

At operation 440, the first device 100 may transmit, to the first server 120, a list of cloud applications of the first device 100. The list of cloud applications of the first device 100 may include at least one of the cloud application(s) installed on the first device 100. In an example, while the operation of the first server 120 making the request for searching for the cloud application(s) installed on the first device 100 may be performed by using a Hyper-Text Transfer Protocol (HTTP), the first device 100 may send the data in a JavaScript Object Notation (JSON) format. In other examples, different implementations are possible.

In a similar manner, at operation 450, the first server 120 may make a request to the second device 110 for searching for the cloud application(s) installed on the second device 110.

At operation 460, the second device 110 may transmit, to the first server 120, a list of cloud applications of the second device 110. The list of cloud applications of the second device 110 may include at least one of the cloud application(s) installed on the second device 110. In an example, while the operation of the first server 120 making the request for searching for the cloud application(s) installed on the second device 110 may be performed by using a Hyper-Text Transfer Protocol (HTTP), the second device 110 may send the data in a JavaScript Object Notation (JSON) format. In other examples, different implementations are possible.

At operation 470, the first server 120 may generate the cloud application installation information. The cloud application installation information may include the list of cloud applications of the first device 100 and the list of cloud applications of the second device 110.

At operation 480, the first server 120 may transmit the cloud application installation information to the second server 130.

At operation 490, the first server 120 may indicate, on a screen of the portal, the cloud application installation information.

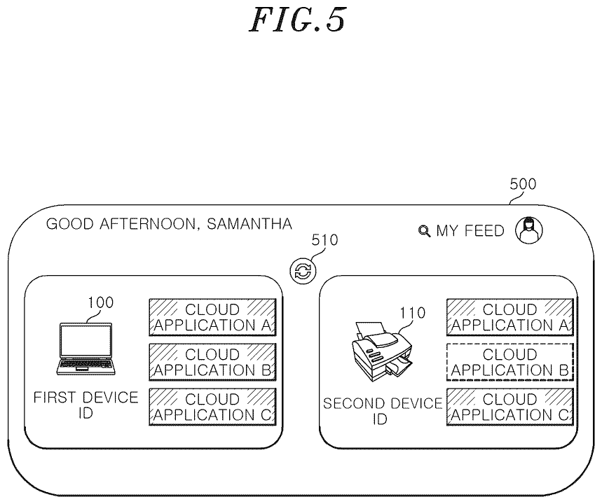

FIG. 5 is a diagram illustrating information regarding installation of cloud applications according to an example.

In some examples, as discussed above, the first server 120 may indicate, on a screen of the portal, the cloud application installation information.

As illustrated in FIG. 5, the first server 120 may indicate, on a screen 500 of the portal, based upon the cloud application installation information as described above with respect to FIG. 4, that the first device 100 has cloud applications A, B, and C installed thereon. Further, the first server 120 may indicate, on the screen 500 of the portal, based upon the cloud application installation information, that the second device 110 has cloud applications A and C installed thereon while cloud application B is not installed thereon.

In order to check whether each of the first device 100 and the second device 110 is logged in to an identical application with an identical user account, the user of the portal may select an object 510 to make a request for user account comparison. Based on the user selecting the object 510, i.e., based on the user requesting a verification of whether there is an application that is logged in to with an identical user account, the first server 120 may indicate, on the screen 500 of the portal, whether each of the first device 100 and the second device 110 is logged in to an identical application with an identical user account at a point in time of receiving the request. In other examples, the user may make such verification request in a non-explicit manner. For example, without receiving from the user any explicit request for the verification, the first server 120 may indicate whether each application is logged in to with an identical user account.

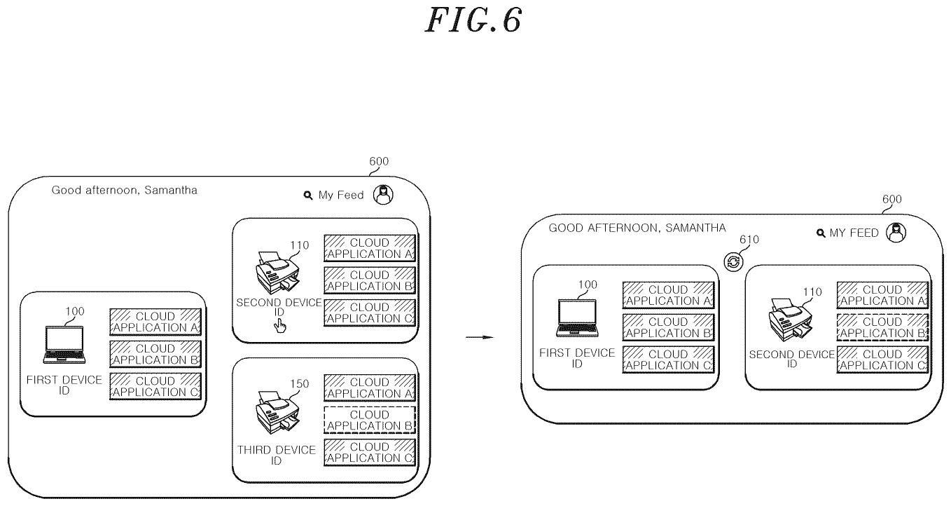

FIG. 6 is a diagram illustrating a selection of a device based on the information regarding the installation of the cloud applications according to an example.

In some examples, the user of the portal may select, from among the plurality of devices registered with the portal, a device whose connection with another is to be checked.

As shown in FIG. 6, the first server 120 may indicate, on a screen 600 of the portal, based upon the cloud application installation information, that each of the first device 100 and the second device 110 has cloud applications A, B, and C installed thereon and that a third device 150 has cloud applications A and C installed thereon while cloud application B is not installed thereon.

The user of the portal may select, from among the second device 110 and the third device 150, based on, e.g., their similarity to the first device 100 in cloud application installation, the second device 110 as a device to manage a connection with the first device 100.

Upon selection of the second device 110, the user of the portal may select an object 610 to make a request for user account comparison, in order to check whether each of the first device 100 and the second device 110 is logged in to an identical application with an identical user account.

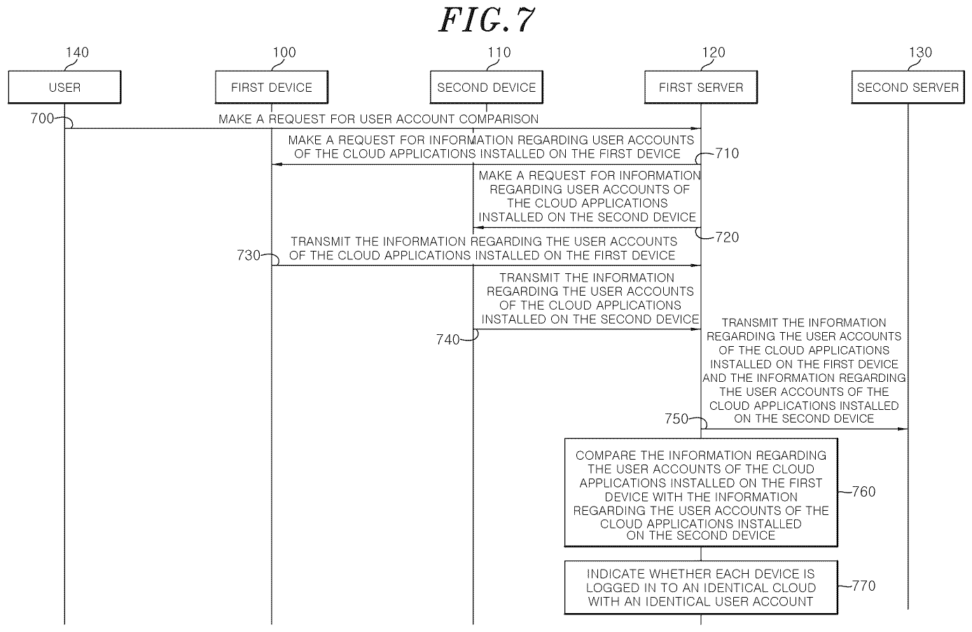

FIG. 7 is a diagram illustrating a process in which a first server indicates whether each of the first device and the second device is logged in to an identical cloud application with an identical user account according to an example.

In some examples, the first server 120 may obtain the first information and the second information. In these examples, the first information may include the information regarding the installation of the cloud applications on the first device 100 and may also include information regarding user accounts thereof. Further, the second information may include the information regarding the installation of the cloud applications on the second device 110 and may also include information regarding user accounts thereof. The first server 120 may indicate, based on the first information and the second information, whether each of the first device 100 and the second device 110 is logged in to an identical cloud application with an identical user account.

Although not shown, the process of FIG. 7 may include some operations described above with respect to FIG. 4, such as the operations of the first server 120 obtaining, for each of the first device 100 and the second device 110, the information regarding the installation of the cloud applications on that device.

FIG. 7 shows that the user 140 of the portal may make, at operation 700, a request to the first server 120 for comparison between user accounts with one of which the first device 100 is logged in to its installed cloud application and with the other of which the second device 110 is logged in to the same cloud application installed thereon.

At operation 710, the first server 120 may make a request to the first device 100 for the information regarding the user accounts of the cloud applications installed on the first device 100. For example, the first device 100 may obtain the user account information from cache information that is managed by the cloud applications.

At operation 720, the first server 120 may make a request to the second device 110 for the information regarding the user accounts of the cloud applications installed on the second device 110. For example, the second device 110 may obtain the user account information through a Single Sign-On (SSO) mechanism.

At operation 730, the first device 100 may transmit, to the first server 120, the information regarding the user accounts of the cloud applications installed on the first device 100.

At operation 740, the second device 110 may transmit, to the first server 120, the information regarding the user accounts of the cloud applications installed on the second device 110.

At operation 750, the first server 120 may transmit, to the second server 130, the information regarding the user accounts of the cloud applications installed on the first device 100 and the information regarding the user accounts of the cloud applications installed on the second device 110.

At operation 760, the first server 120 may compare the information regarding the user accounts of the cloud applications installed on the first device 100 with the information regarding the user accounts of the cloud applications installed on the second device 110.

At operation 770, the first server 120 may indicate, on a screen of the portal, whether each of the first device 100 and the second device 110 is logged in to an identical cloud application with an identical user account. To sum up, the first server 120 may obtain the first information, including the information regarding the installation of the cloud applications on the first device 100 and the information regarding the user accounts thereof, and the second information, including the information regarding the installation of the cloud applications on the second device 110 and the information regarding the user accounts thereof, and, based on the first information and the second information, indicate whether each of the first device 100 and the second device 110 is logged in to an identical cloud application with an identical user account.

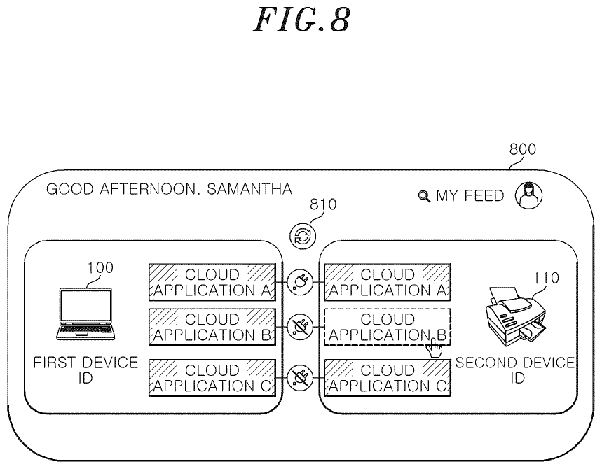

FIG. 8 is a diagram illustrating an indication of whether each of the first device and the second device is logged in to an identical cloud application with an identical user account according to an example.

As shown in FIG. 8, in order to check, on a screen 800 of the portal, whether each of the first device 100 and the second device 110 is logged in to an identical application with an identical user account, the user of the portal may select an object 810 to make a request for user account comparison.

If the user selects the object 810, the first server 120 may indicate whether each of the first device 100 and the second device 110 is logged in to an identical application with an identical user account. Further, the first server 120 may indicate to the user a cloud application that is not installed both on the first device 100 and on the second device 110.

For example, as shown in FIG. 8, the first server 120 may indicate that each of the first device 100 and the second device 110 is logged in to cloud application A with an identical user account and, accordingly, the first device 100 and the second device 110 are connectable to each other through this cloud application, that cloud application B is not installed on the second device 110 and, accordingly, the first device 100 and the second device 110 are not connectable to each other through this cloud application, and that cloud application C is installed in common on the first device 100 and the second device 110, each of which is logged in thereto with its respective different user account, and, accordingly, the first device 100 and the second device 110 are not connectable to each other through this cloud application.

As can be seen from FIG. 8 with respect to cloud application B, a cloud application that is not installed both on the first device 100 and on the second device 110 may be indicated in a manner different from that for a cloud application installed on both of the devices.

In this illustrated example, the user of the portal may desire to install, on the second device 110 through the portal, cloud application B, which is not yet installed thereon. For example, if the user selects cloud application B, which is indicated on the screen 800 of the portal as not being installed on the second device 110, the first server 120 may receive a request for installation of cloud application B on the second device 110 and operate such that cloud application B may be installed on the second device 110.

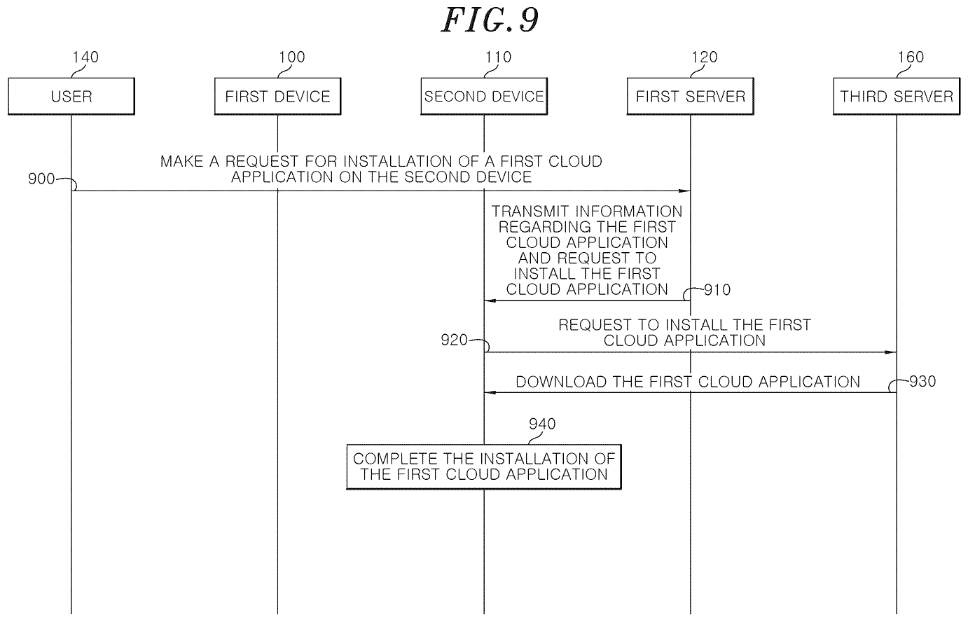

FIG. 9 is a diagram illustrating a process of installing a first cloud application which is not yet installed both on the first device and on the second device according to an example.

In some examples, the first server 120 may receive a request to install a first cloud application on one of the first and the second devices, on which device the first cloud application is not yet installed. Further, the first server 120 may transmit, to the device on which the first cloud application is not yet installed, the request so as to complete the installation of the first cloud application through an application installation server. For example, the first cloud application may be a cloud application that is not yet installed both on the first device 100 and on the second device 110.

FIG. 9 shows that the user 140 of the portal may make, at operation 900, a request for installation of the first cloud application on the second device 110.

At operation 910, the first server 120 may transmit information regarding the first cloud application to be installed on the second device 110 and request the installation of the first cloud application.

At operation 920, the second device 110 may request a third server 160 to install the first cloud application. The third server 160 may be an application installation server.

At operation 930, the third server 160 may download the first application to the second device 110.

At operation 940, the second device 110 may complete the installation of the first cloud application.

As can be seen from FIG. 8 with respect to cloud application C, there may be a cloud application that is installed in common on the first device 100 and the second device 110, each of which is logged in thereto with a respective different user account, and, accordingly, the first device 100 and the second device 110 are not connectable to each other through the cloud application. In an example, the first device 100 and the second device 110 may be logged in to cloud application C with two different user accounts, respectively. In this example, the user may make a request for synchronization to an identical user account with which each of the first device 100 and the second device 110 is logged in to cloud application C. In that case, the first server 120 may perform an operation of ensuring that each of the first device 100 and the second device 110 is logged in to cloud application C with the identical user account.

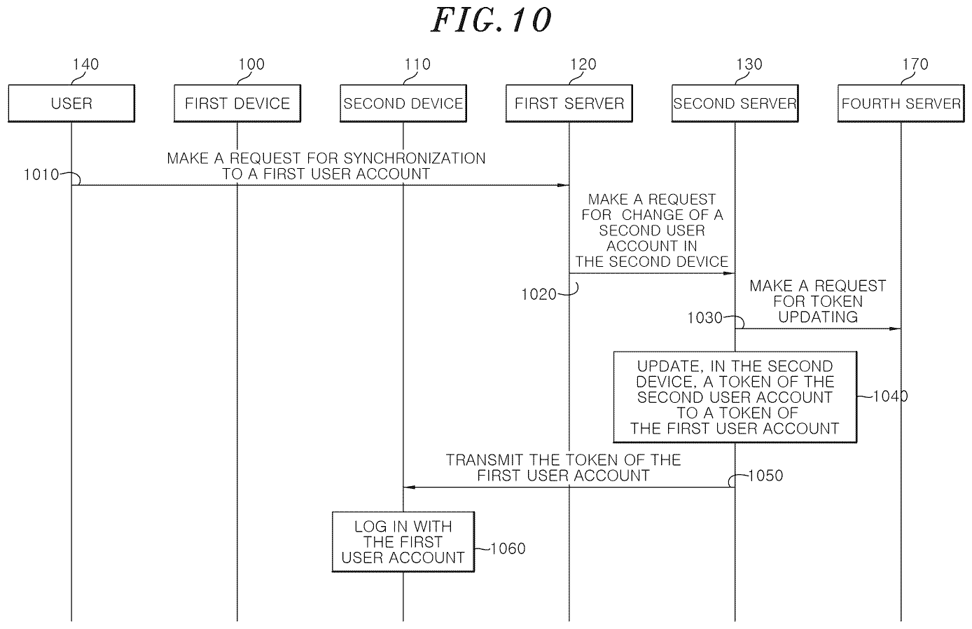

FIG. 10 is a diagram illustrating a process of ensuring that each of the first device and the second device is logged in to an identical cloud application with an identical user account according to an example.

In an example where the first device 100 is logged in to a cloud application with a first user account while the second device 110 is logged in to the identical cloud application with a second user account, the first server 120 may receive a request for synchronization to the first user account, rather than to the second user account, and cause, based on the synchronization request, the second device 110 to be logged in to the identical cloud application with the first user account.

The example process of FIG. 10 is described in the context of a token-based authentication scheme by which the application authenticates the user. At operation 1010, the user 140 of the portal may make a request to the first server 120 for synchronization to the first user account. In other words, the user 140 of the portal may request the first server 120 to ensure that each of the first device 100 and the second device 110 is logged in with the first user account.

At operation 1020, the first server 120 may make a request to the second server 130 for change of the user account in the second device 110 so that the second device may be logged in to the identical application with the first user account.

At operation 1030, the second server 130 may make a request to a fourth server 170 for updating of a token for use in the authentication of the user with the application, such as a token of the second user account. The fourth server 170 may be a server for serving the identical cloud application. That is, the second server 130 may request the fourth server 170 to update the user account token stored in the second device 110. In that case, the fourth server 170 may send to the second server 130 a token of the first user account.

At operation 1040, the second server 130 may update, in the second device 110, the token of the second user account to the token of the first user account.

At operation 1050, the second server 130 may transmit the token of the first user account to the second device 110.

At operation 1060, the second device 110 may be logged in to the identical cloud application with the first user account. As such, the first device 100 and the second device 110 may stay logged in together to the identical cloud application with the first user account.

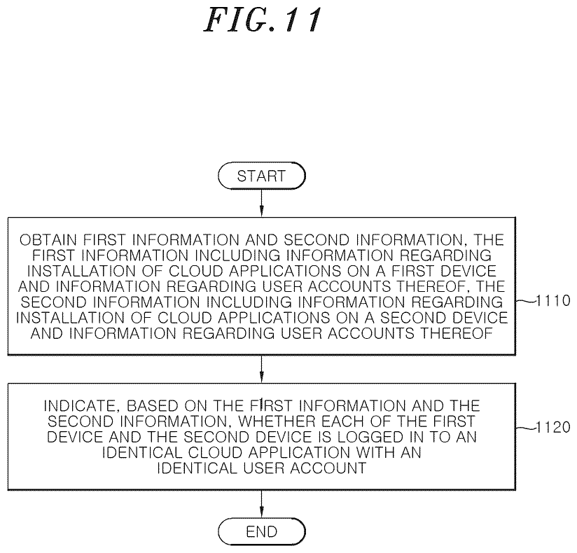

FIG. 11 is a flow diagram illustrating a method for connection between devices according to an example.

As shown in FIG. 11, at operation 1110, the first server 120 may obtain first information, including information regarding installation of cloud applications on a first device and information regarding user accounts thereof, and second information, including information regarding installation of cloud applications on a second device and information regarding user accounts thereof.

At operation 1120, the first server 120 may indicate, based on the first information and the second information, whether each of the first device and the second device is logged in to an identical cloud application with an identical user account.

For example, the first server 120 may indicate, based on the first information and the second information, a first cloud application that is not installed both on the first device and on the second device.

For example, the first server 120 may receive a request to install the first cloud application on a device which is one of the first and the second devices and on which the first cloud application is not installed. Further, the first server 120 may transmit, to the device on which the first cloud application is not installed, the request so as to complete the installation of the first cloud application through an application installation server.

For example, based on the first device being logged in to the identical cloud application with a first user account while the second device is logged in to the identical cloud application with a second user account, the first server may receive a request for synchronization to the first user account, other than to the second user account, and cause, based on the synchronization request, the second device to be logged in to the identical cloud application with the first user account.

For example, the first server 120 may request a user account management server to make a change of a user account such that the second device is logged in to the identical application with the first user account.

For example, a token of the second user account, which token may be stored for use in the identical cloud application on the second device, may be updated by the user account management server to a token of the first user account, and the second device may be logged in to the identical cloud application with the first user account.

For example, the first device may include a user device and the second device may include an image forming device to connect to the user device.

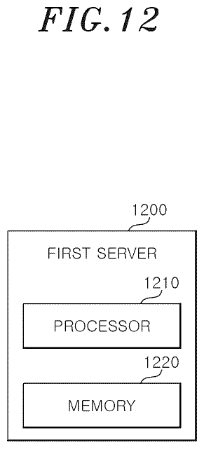

FIG. 12 is a block diagram schematically illustrating a first server according to an example.

As shown in FIG. 12, the example first server, denoted as 1200, may include a processor 1210 and a memory 1220. In other examples, the first server 1200 may also include an additional component. The first server 120 as described with respect to FIGS. 1 to 11 may be identical to the first server 1200 of FIG. 12.

In some examples, the memory 1220 may be implemented in hardware to store a variety of data to be processed in the first server 1200, for example, a program for processing and control of the processor 1210.

The memory 1220 may be implemented with Random Access Memory (SRAM), such as Dynamic Random Access Memory (DRAM), Static Random Access Memory (SRAM), or the like, Read-Only Memory (ROM), Electrically Erasable Programmable Read-Only Memory (EEPROM), CD-ROM, Blu-ray or other optical disc storage, Hard Disk Drive (HDD), Solid State Drive (SSD), flash memory, or the like.

The processor 1210 may control the overall functionality of the first server 1200. For example, the processor 1210 may execute a program stored in the memory 1220 to control an input unit (not shown), a display (not shown), a communications unit (not shown), the memory 1220, or the like, thereby controlling, e.g., some operations of the first server 1200.

The processor 1210 may be implemented using Application Specific Integrated Circuits (ASICs), Digital Signal Processors (DSPs), Digital Signal Processing Devices (DSPDs), Programmable Logic Devices (PLDs), Field Programmable Gate Arrays (FPGAs), controllers, microcontrollers, microprocessors, or other electrical devices for performing functions.

In an example where the communications unit is included in the first server 1200, the communications unit may include a component that enables the first server 1200 to communicate wirelessly and/or in a wired manner. For example, the communications unit may include at least one of a short-range communications unit (not shown), a mobile communications unit (not shown), a broadcast receiver unit (not shown), and the like.

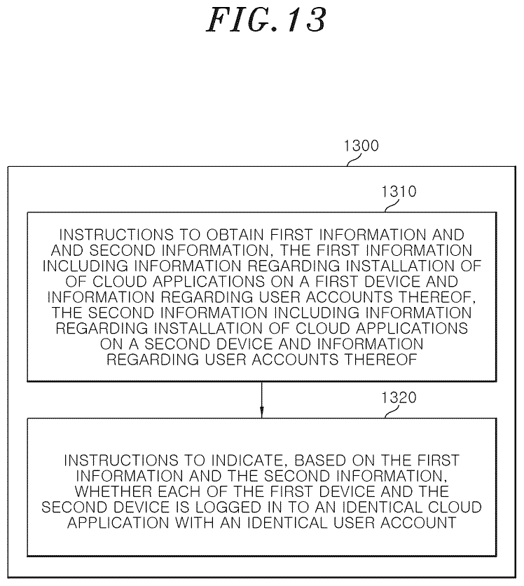

FIG. 13 is a schematic illustration of a non-transitory computer readable recording medium having stored therein a computer program including instructions executable by a processor to perform operations according to an example.

As shown in FIG. 13, a non-transitory computer readable recording medium 1300 stores a computer program that is executable by a processor and programmable to implement some operations of the aforementioned example methodology. The computer program on the non-transitory computer readable storage medium 1300 may include a set of program instructions that direct the processor to perform specific operations.

As shown in FIG. 13, the computer program includes instructions 1310 to obtain first information and second information, the first information including information regarding installation of cloud applications on a first device and information regarding user accounts thereof, the second information including information regarding installation of cloud applications on a second device and information regarding user accounts thereof. The computer program on the non-transitory computer readable storage medium 1300 further includes instructions 1320 to indicate, based on the first information and the second information, whether each of the first device and the second device is logged in to an identical cloud application with an identical user account.

As can be seen, upon execution of the computer program stored in the computer readable recording medium 1300, the instructions 1310 and 1320 illustrated in FIG. 13, as well as the example operations described above with respect to FIGS. 4, 7, 9, and 10, may be performed by the computer including a processor.

The above-described computer readable recording medium may be a non-transitory readable medium. The term “non-transitory readable medium” as used herein refers to a medium that is capable of semi-permanently storing data and is readable by an apparatus, rather than a medium, e.g., a register, a cache, a volatile memory device, etc., that temporarily stores data. For example, the foregoing program instructions may be stored and provided in a CD, a DVD, a hard disk, a Blu-ray disc, a USB, a memory card, a ROM device, or any of other types of non-transitory readable media.

In a particular example, the example methodology disclosed herein may be incorporated into a computer program product. The computer program product may be available as a product for trading between a seller and a buyer. The computer program product may be distributed in the form of a machine-readable storage medium, e.g., compact disc read only memory (CD-ROM), or distributed online through an application store, e.g., PlayStore™. For the online distribution, at least a portion of the computer program product may be temporarily stored, or temporarily created, in a storage medium such as a server of the manufacturer, a server of the application store, or a storage medium such as memory of a relay server.

The foregoing description has been presented to illustrate and describe examples. It should be understood that many modifications and variations are possible in light of the above teaching. In various examples, suitable results may be achieved if the above-described techniques are performed in a different order, and/or if some of the components of the above-described systems, architectures, devices, circuits, and the like are coupled or combined in a different manner, or substituted for or replaced by other components or equivalents thereof.

Therefore, the scope of the disclosure is not to be limited to the precise form disclosed, but rather defined by the following claims and equivalents thereof.

What is claimed is:

1. A method for connection between devices, the method comprising:
obtaining first information and second information, the first information comprising information regarding installation of a cloud application on a first device and information regarding a user account thereof, the second information comprising information regarding installation of a cloud application on a second device and information regarding a user account thereof; and
indicating, based on the first information and the second information, whether each of the first device and the second device is logged in to an identical cloud application with an identical user account.

2. The method of claim 1, further comprising:
indicating, based on the first information and the second information, a first cloud application that is not installed both on the first device and on the second device.

3. The method of claim 2, further comprising:
receiving a request to install the first cloud application on a device which is one of the first device or the second device and on which the first cloud application is not installed; and
transmitting, to the device on which the first cloud application is not installed, the request so as to complete the installation of the first cloud application through an application installation server.

4. The method of claim 1, further comprising, based on the first device and the second device being logged in to the identical cloud application with a first user account and a second user account, respectively:
receiving a request for synchronization to the first user account; and
causing, based on the request, the second device to be logged in to the identical cloud application with the first user account.

5. The method of claim 4, wherein the causing, based on the request, the second device to be logged in to the identical cloud application with the first user account further comprises:
requesting a user account management server to make a change of a user account such that the second device is logged in to the identical cloud application with the first user account.

6. The method of claim 5,
wherein a token of the second user account, which token is stored for use in the identical cloud application on the second device, is updated by the user account management server to a token of the first user account, and
wherein the second device is logged in to the identical cloud application with the first user account.

7. The method of claim 1,
wherein the first device comprises a user device, and
wherein the second device comprises an image forming device to connect to the user device.

8. A server device, comprising:
a memory to store instructions; and
a processor to execute the instructions to cause the processor to:
obtain first information and second information, the first information comprising information regarding installation of cloud applications on a first device and information regarding user accounts thereof, the second information comprising information regarding installation of cloud applications on a second device and information regarding user accounts thereof; and
indicate, based on the first information and the second information, whether each of the first device and the second device is logged in to an identical cloud application with an identical user account.

9. The server device of claim 8, wherein the instructions further cause the processor to:
indicate, based on the first information and the second information, a first cloud application that is not installed both on the first device and on the second device.

10. The server device of claim 9, wherein the instructions further cause the processor to:
receive a request to install the first cloud application on a device which is one of the first device or the second device and on which the first cloud application is not installed; and
transmit, to the device on which the first cloud application is not installed, the request so as to complete the installation of the first cloud application through an application installation server.

11. The server device of claim 8, wherein the instructions further cause the processor to, based on the first device and the second device being logged in to the identical cloud application with a first user account and a second user account, respectively:
receive a request for synchronization to the first user account; and
perform, based on the request, the synchronization such that the second device is logged in to the identical cloud application with the first user account.

12. The server device of claim 11, wherein the instructions further cause the processor to:
request a user account management server to make a change of a user account such that the second device is logged in to the identical cloud application with the first user account.

13. The server device of claim 12,
wherein a token of the second user account, which token is stored for use in the identical cloud application on the second device, is updated by the user account management server to a token of the first user account, and
wherein the second device is logged in to the identical cloud application with the first user account.

14. The server device of claim 8,
wherein the first device comprises a user device, and
wherein the second device comprises an image forming device to connect to the user device.

15. A non-transitory computer readable recording medium including instructions to cause a processor to perform operations for connection between devices, the non-transitory computer readable recording medium comprising:
instructions to obtain first information and second information, the first information comprising information regarding installation of cloud applications on a first device and information regarding user accounts thereof, the second information comprising information regarding installation of cloud applications on a second device and information regarding user accounts thereof; and
instructions to indicate, based on the first information and the second information, whether each of the first device and the second device is logged in to an identical cloud application with an identical user account.
